(19) United States
(12) Patent Application Publication
(10) Pub. No.: US 2012/0097818 A1
(43) Pub. Date: Apr. 26, 2012

(54) FURNITURE LEG FLOOR PROTECTOR

(76) Inventor: Pierre Desmarais, Cantely (CA)

(21) Appl. No.: 13/336,957

(22) Filed: Dec. 23, 2011

Related U.S. Application Data
(63) Continuation of application No. 12/082,054, filed on Apr. 8, 2008, now abandoned.

(30) Foreign Application Priority Data
Apr. 20, 2007 (CA) 2,585,597

(51) Int. Cl. A47B 91/12; B29C 45/14

(52) U.S. Cl. 248/345.1; 264/257

(57) ABSTRACT

The present invention relates to a furniture leg floor protector. The invention is an improvement over the prior art in that firstly it has a flexible upper sleeve which is stretchable and adapted to receive a leg of many dimensions. This overcomes previous problems with floor protectors which after a certain age and wear, and because of semi-rigid construction, tend to fall off the furniture legs. The invention also presents a process for installing the felt pad on the bottom of the floor protector by means of molding around the pad during molding of the floor protector. This not only fixedly secures the pad to the rest of the floor protector in an integral manner; but also alleviates applying the pads to the floor protector by means of adhesive as a second step in the manufacturing process after molding.

### CROSS-REFERENCE TO RELATED APPLICATIONS

This application is a Continuation of U.S. patent application Ser. No. 12/082,054 filed Aug. 4, 2008 and claims priority from Canadian Patent Application No. 2,585,597 filed in Canada on Apr. 20, 2007. The entire contents of these two applications are incorporated herein by reference.

### FIELD OF THE INVENTION

This invention relates to furniture leg floor protectors and a process for making them and is applicable to furniture leg floor protectors adapted for use with chair, table, stool, sofa, or any other furniture leg.

### BACKGROUND

Furniture leg floor protectors have commonly been in use for many years. These are used to avoid damage to for example hardwood floors when a chair or table is moved. They also reduce noise in the classroom where children tend to move their desks and chairs around often making an irritating noise.

Almost all furniture leg floor protectors suffer from two problems which the present invention seeks to solve. Most present day floor protectors are injection-molded out of a transparent, rubber-like material such as plasticized thermo-plastic elastomer. The product is semi-rigid, including the upper sleeve with circular side walls. The upper sleeve is adapted to receive a leg of furniture such as a chair or table. After the molding process, a felt pad is applied to the bottom of the elastomer rubber-like body on the bottom thereof. The felt pad may be constructed of wool or felt. The felt pad can also be formed of a deformable resilient material to stabilize the object to give a support surface. The felt pad is usually secured to the floor protector body by mechanical bonding or adhesive bonding.

The addition of the felt pad is an extra step in the manufacturing process, which must sometimes be done by hand and thus is labor intensive. Moreover, over time the adhesives tend to wear out, and by constant movement of the furniture leg, the felt pad finally becomes detached and a new felt pad must be added. The other problem with the semi-rigid elastomer protectors, which is addressed by the present invention, is that the upper sleeve, after significant use, becomes somewhat enlarged and the protector tends to fall off the chair or table leg.

Attempts to increase friction and long life of the upper sleeve of a floor protector have been mildly successful. For example, in U.S. Publication No. 2004/0123421 A1, a corrugated sleeve having folds therein to increase friction has been utilized. It would appear however that the complexity of the molding process could make this option uneconomical.

An object of one aspect of this invention is to provide an easier way to attach a pad of felt to the bottom of a floor protector. A secondary object is improve the ease and security of the attachment of the protector to the furniture leg.

According to one aspect of the present invention, there is provided a process for injection-molding a furniture leg floor protector comprising a body of plasticized thermo-plastic elastomer material and a felt pad attached thereto, the body having a cylindrical portion sized to receive a foot portion of said furniture leg and an integral bottom wall, the felt pad having a fibrous surface attached to an underside, in use, of said bottom wall, the process comprising:
providing a mold formed for injection-molding said body of said floor protector,
placing said felt pad into said mold with said fibrous surface at a position corresponding to said bottom wall,
injecting molten plasticized thermo-plastic elastomer material into said mold and onto said fibrous surface of said felt pad so that said some of said material infiltrates interstices between fibers of said fibrous surface, and
removing said protector with said felt pad permanently attached to said bottom wall of said body by said material infiltrated into said interstices. Preferably, the material is substantially transparent.

According to a second aspect of the present invention, there is provided a furniture leg floor protector made by the process of the first aspect and comprising a body of plasticized thermo-plastic elastomer material and a felt pad attached thereto, the body having a preferably substantially transparent cylindrical portion sized to receive a foot portion of said furniture leg and an integral bottom wall, the felt pad having a fibrous surface permanently attached to said bottom wall by infiltration of molten elastomer material into interstices between fibers of said fibrous surface. during molding followed by and cooled the felt pad is permanently during the molding process without application of adhesive.

Thus, with regard to the first problem, the present inventor has found that, if a felt pad, such as 100% wool felt, is placed in the bottom of the mold, when the injection-molding process takes place, the molten plasticized thermo-plastic elastomer injected into the mold infiltrates interstices between fibers of the upper fibrous surface of the felt pad. Once the elastomer material has set, cooled and been removed from the mold, the felt pad is an integral part of the floor protector, and cannot be separated therefrom without damage. That is to say, it is permanently affixed.

The second problem is addressed by embodiments of either aspect in which the cylindrical sidewall comprises a semi-rigid lower sidewall portion sized to receive a foot portion of said furniture leg and having said integral bottom wall, and a flexible upper sidewall portion elastically stretchable to allow an end of the foot portion to be passed through the upper sidewall portion and into the lower sidewall portion, the upper sidewall frictionally elastically engaging the furniture leg above the foot portion in use.

The upper sidewall may be thinner than the lower side wall, the upper side wall being sufficiently stretchable to roll outwards or fold outwards over said lower side wall and unroll or unfold up the leg during installation to frictionally adhere to the leg, constantly exerting an inward force towards the leg and thus preventing the floor protector from falling off the furniture leg. Moreover, in the folded down or rolled down sleeve position, the protector is small and easier to ship and handle, as it takes up a smaller volume.

In preferred embodiments of the present invention, the furniture leg protector comprises a one piece plastic elastomer body with a felt pad, preferably 100% wool, embedded in the bottom during the molding process. The protector can take many shapes, providing that there is sufficient friction between the upper sleeve/circular side wall and the chair leg. The felt pad can be rounded or have an aperture therein or simply one piece with planar top and bottom surfaces. After molding, the felt pad must protrude slightly from the elastomer body in order to have proper contact with the floor. The stretchable upper sleeve is generally constructed to be much thinner than the lower circular wall, which must be more rigid to support the bottom of the chair leg. The thickness of the sleeve can diminish from the bottom to the top, i.e. the remote end which provides access for the chair leg during installation. It may also be tapered or in some cases cone-shaped. In other embodiments, the sleeve upper side wall can have a concave outer side and a convex inner side. It is of course possible to also have an upper sleeve or upper side wall of equal thickness in the form of a cylinder.

### BRIEF DESCRIPTION OF THE DRAWINGS

Preferred embodiments of the invention will be described in detail by way of example only in conjunction with the following drawings, wherein:

FIG. 1 is a transverse cross section and top view of a prior art floor protector;

FIG. 2 is a longitudinal section of a prior art floor protector;

FIG. 3 is a longitudinal cross section of a preferred embodiment of the present invention;

FIG. 4 is a longitudinal cross section of the embodiment shown in FIG. 3, wherein the upper circular side walls have been rolled down for transport and pre-installation;

FIG. 5 is a longitudinal cross section of the embodiment shown in FIG. 3, wherein the upper sleeve or side walls have been folded down for transport and pre-installation;

FIGS. 6, 6a and 6b are a longitudinal cross section, top view, and bottom view, respectively, of another embodiment of the present invention;

FIGS. 7, 7a and 7b are respectively a longitudinal cross section, top view and bottom view of another embodiment of the present invention;

FIGS. 8, 8a and 8b are respectively a longitudinal cross section, top view and bottom view of a cylindrical embodiment of the present invention;

FIGS. 9, 9a and 9b are respectively, a longitudinal section, top view, and bottom view of another embodiment of the present invention;

FIGS. 10, 10a and 10b are respectively a longitudinal cross section, a top view, and bottom view of the embodiment shown in FIG. 3;

FIGS. 11, 11a and 11b are respectively a longitudinal cross section, a top view, and bottom view of another embodiment of the invention;

FIGS. 12, 12a and 12b show an embodiment of the invention showing a curved felt bottom pad;

FIGS. 13, 13a and 13b show a circular bottom pad, having planar top and bottom surfaces; and

FIGS. 14, 14a and 14b show a bottom felt pad having a circular aperture in the center thereof.

### DETAILED DESCRIPTION OF PREFERRED EMBODIMENTS

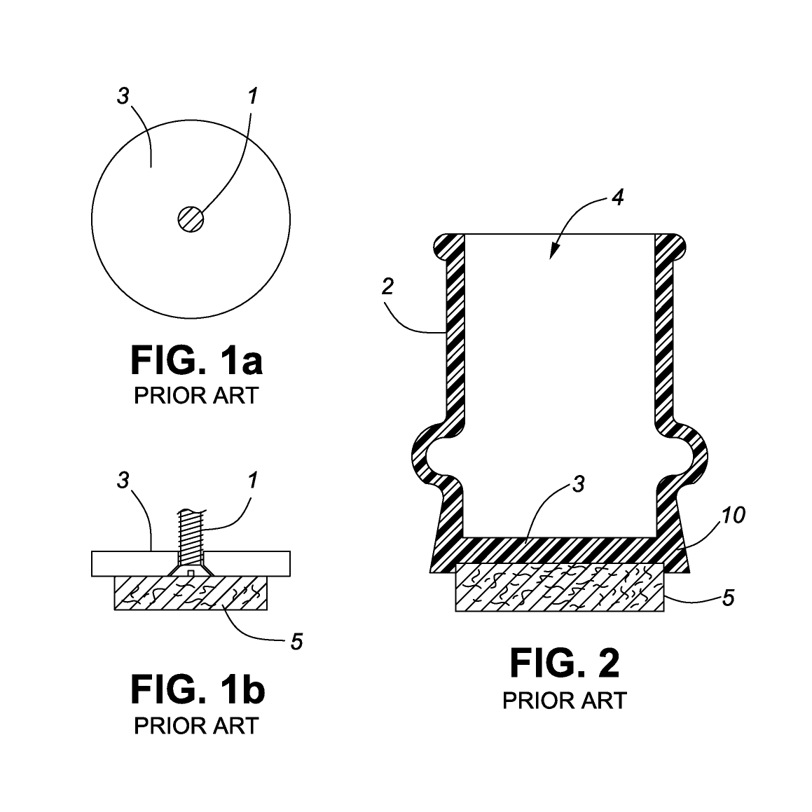

FIG. 1 shows a prior art furniture leg floor protector device. It has a bottom wall (3). The configuration is generally cylindrical and it is basically composed of an elastomer rubber-like product. A felt pad (5) is added by double face tape to the bottom of bottom wall (3) and a screw adheres the protector to a furniture leg bottom portion in the normal course of construction.

FIG. 2 shows another prior art floor protector. It is comprised of a furniture leg floor protector having a semi-rigid circular body (2). A bottom wall (3) is integrally molded as a part of the circular body (2). A circumferential lip, descending from body (2), is marked (10). A pad 5 is placed in the recess below bottom wall (3), and secured with pressure sensitive hot-melt adhesive.

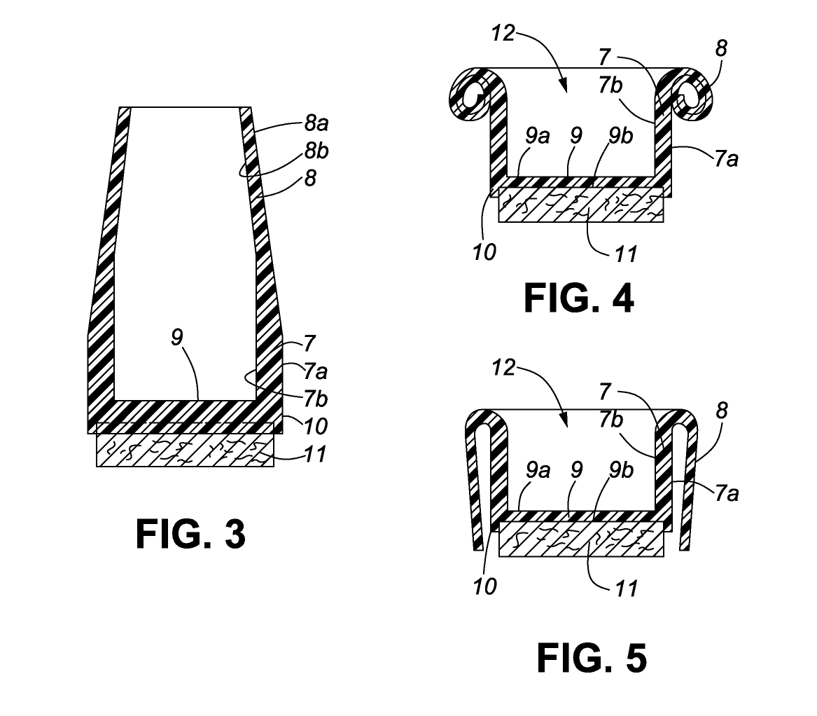

FIG. 3 shows a preferred embodiment of the present invention. It is a longitudinal cross section. One notes that the upper circular, flexible, stretchable wall (8) is much narrower than the lower circular wall (7). Wall (8) has an outside surface (8a) and an inside surface (8b). The lower portion of lower circular wall (7) also includes a circumferential lip (10). This is adapted to seat a typical circular wool felt pad (11) which is planar in design on its upper and lower surfaces. Lower circular wall (7) is semi-rigid and has an outer side (7a) and an interior side (7b). It is integrally connected to bottom wall 9 and circumferential lip (10). The advantage of the upper circular wall (8) is that it becomes, with lesser thickness, very flexible and adapted with greater friction to adhere to a bottom of a chair leg or table leg. The thicker lower portions (7), (9), (10), provide some rigidity to the floor protector. Although wool felt is preferred, the felt pad may comprise polyester, wool, nylon, rayon, polytetrafluoroethylene (e.g., Teflon) or cotton.

FIG. 4 shows a rolled storage position longitudinal cross section of the embodiment shown in FIG. 2. The upper circular side wall or sleeve (8) being thin, is able to be rolled outwardly and downwardly to abut lower side wall (7). Lower side wall (7) has an inside wall (7b) and an outside wall (7a). Similarly, the bottom wall (9), which is integrally joined to lower circular side wall (7) during molding, by infiltration of molten plasticized thermoplastic elastomer material into interstices between fibers at the surface of the felt pad placed in the mold, has an upper side (9a) and a lower side (9b). The felt pad (11) is adapted to fit upwardly under the bottom side (9b) of the bottom side wall. FIG. 4 shows a longitudinal conventional shipping and handling configuration of the present invention.

FIG. 5 shows another shipping and handling configuration of an embodiment of the invention shown in FIG. 3. Thinner flexible and stretchable side wall (8) has been folded outwards and downwards to be adjacent to lower circular side wall (7). Felt pad (11) remains attached after the molding process, thus the embodiment of the present invention shown in FIG. 5 or FIG. 4 can be shipped in a relatively compact state to save volume requirements.

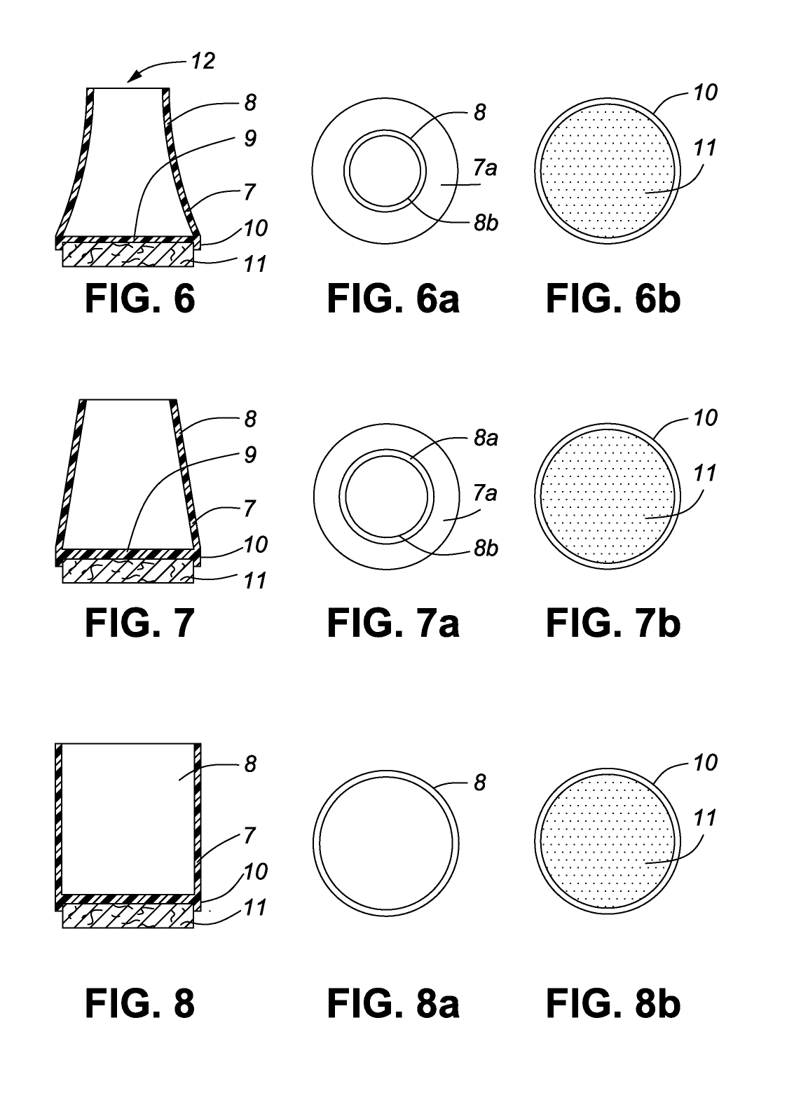

FIGS. 6, 6a and 6b show a variant of the present invention. Upper circular side wall (8) is concave outwardly, and adjoins lower side wall (7). This concave wall increases flexibility and fits more furniture leg shapes. The curved conical shape increases grip at the top of the protector.

FIG. 7 shows another variant of the present invention wherein the semi-rigid circular lower side wall (7) merges almost imperceptibly into the upper side wall (8). The two walls apparently having the same thickness. The circumference of the top portion of flexible, stretchable side wall (8) at its top is significantly less than the circumference of circular side wall (7). A felt (11) has been appropriately applied to the product.

In FIG. 8, the cylindrical side walls are basically vertical with no tapering. Upper side walls (8) are perfectly in line with lower side walls (7). This particular embodiment of the invention, with a cylindrical shape, improves production speed, but is not as strong.

It should be understood that the embodiments shown in FIGS. 6, 7 and 8 are not preferred embodiments of the invention, since their ability to frictionally attach to furniture legs are limited.

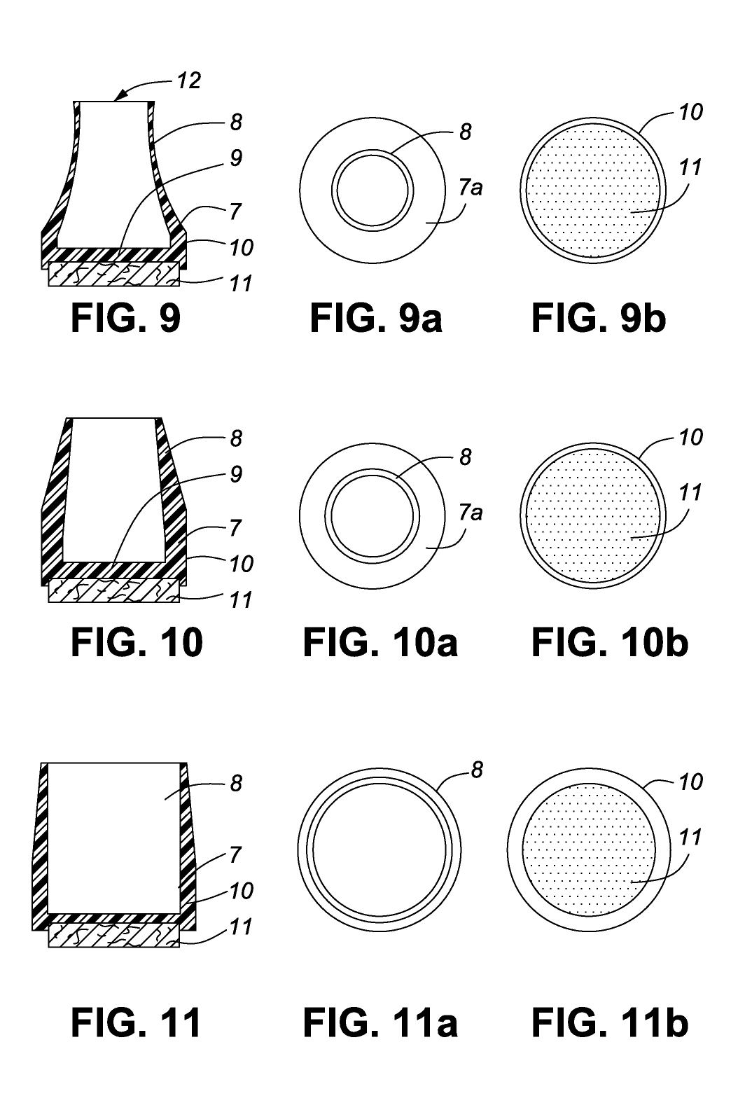

FIGS. 9, 9a, and 9b show a variant of the present invention. There is a tapered side wall (8) commencing at the top of the lower circular side wall (7) and ending at the upper end of the side wall (8). This tapered wall increases stability at the bottom of the protector, and its curved conical shape, which is concave on the outside of the side wall (8) and convex on the inside of the side wall (8), increases grip at the opening of the protector.

FIG. 10 shows another variant of lower circular side wall (7) and upper circular side wall (8) which is tapered inwardly and upwardly and the side wall (8) is thinner at the top than at the bottom. The usual lower circumferential lip 10 surrounds the felt pad (11), which is situated under the bottom wall (9).

FIGS. 11, 11a and 11b, showing a longitudinal cross section, a top view and a bottom view, respectively, show a substantially cylindrical upper and lower sleeve. However, there is a tapered wall to increase stability at the bottom of the protector. The cylindrical shape improves production speed, because it's easier to remove from the mold. The upper circular side wall (8) can, for the purposes of shipping and handling, be either folded downwardly or rolled downwardly, as its flexibility and stretchability is significantly greater than that of lower circular side wall (7).

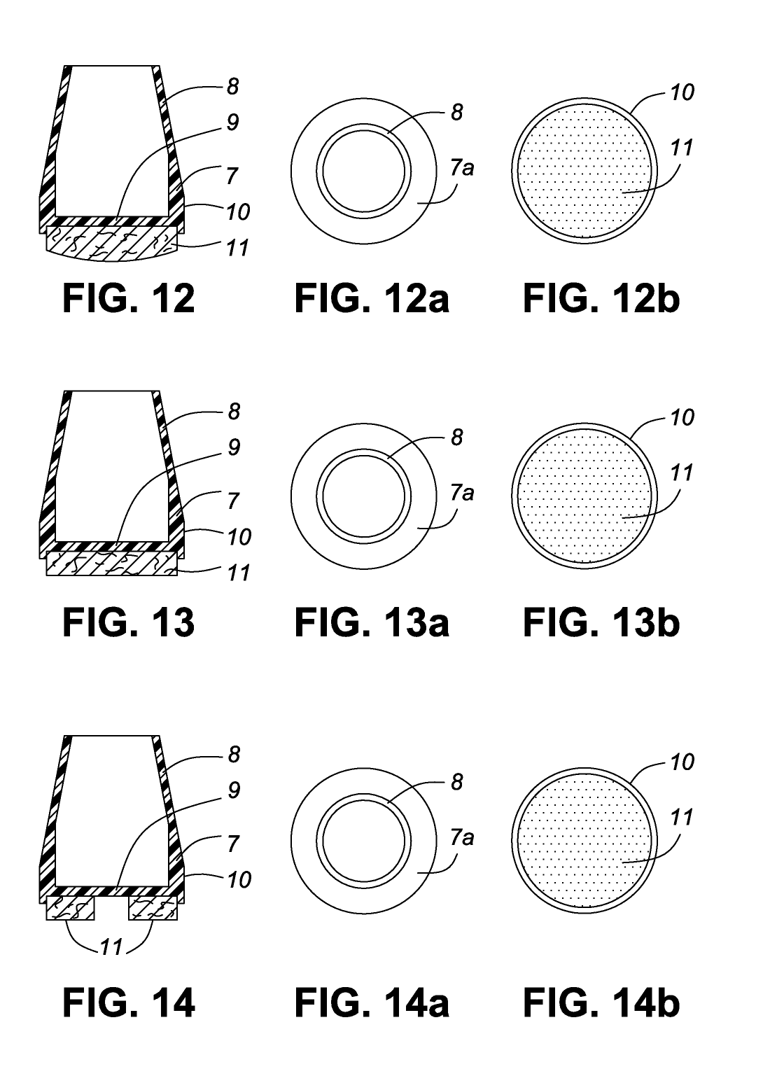

FIGS. 12, 13 and 14, show longitudinal cross sections of varying embodiments of the invention, along with their counterparts 12a, 13a and 14a top views, respectively, and 12b, 13b and 14b bottom views, respectively.

In FIG. 12, felt pad (11) has a bottom side which is outwardly convex.

In FIG. 12, the felt pad (11) has a planar upper surface and a planar lower surface and is circular in form.

Finally, in FIG. 13 a felt pad is shown having an aperture (13). It is believed that injection through the bottom hole could increase clarity of the product and visual appeal. In terms of production, a hole or aperture (13) in felt pad (11) will decrease cost and not particularly sacrifice stability.

In conclusion, it is to be understood that a specific improvement in preferred embodiments of this invention is the flexible, stretchable upper side wall, circular in form, adapted to frictionally engage a furniture leg of any dimension. Further benefits may derive from the manufacture of the integrally molded furniture leg protector, wherein the injection molding takes place on and around the felt pad and the molten plasticized thermoplastic elastomer material infiltrates the interstices between fibers of the upper fibrous surface of the felt pad so that when the body has been removed and cooled the infiltrated material secures the pad permanently to the bottom wall without separate adhesive. It is a novel and effective way to ensure fixation of the felt pad to the thermoplastic elastomer body to ensure long life of the product.

1. A process for injection-molding a furniture leg floor protector comprising a body of plasticized thermo-plastic elastomer material and a felt pad attached thereto, the body having a preferably substantially transparent cylindrical portion sized to receive a foot portion of said furniture leg and an integral bottom wall, the felt pad having a fibrous surface attached to an underside, in use, of said bottom wall, the process comprising:
providing a mold formed for injection-molding said body of said floor protector,
placing said felt pad into a part of said mold with said fibrous surface at a position corresponding to said bottom wall,
injecting molten plasticized thermo-plastic elastomer material into said mold and onto said fibrous surface of said felt pad so that said material partially infiltrates interstices between fibers of said fibrous surface, and
removing said protector with said felt pad permanently attached to said bottom wall of said body by said material infiltrated into said interstices.

2. A process for injection-molding a furniture leg floor protector having a body of plasticized thermo-plastic elastomer material and a felt pad having a fibrous surface, the body comprising a preferably substantially transparent cylindrical sidewall having a semi-rigid lower sidewall portion sized to receive a foot portion of said furniture leg and having an integral bottom wall, and a flexible upper sidewall portion elastically stretchable to allow the foot portion to be inserted through the upper sidewall and received in the lower sidewall portion and then to frictionally elastically engage the furniture leg above the foot portion, the process comprising:
providing a mold formed for injection-molding said body of said floor protector,
placing said felt pad into a part of said mold so that said fibrous surface corresponds to said bottom wall,
injecting molten plasticized thermo-plastic elastomer material into said mold and onto said fibrous surface of said felt pad so that said material infiltrates interstices between fibers of said fibrous surface, and
removing said protector with said felt pad permanently attached to said bottom wall of said body by said material infiltrated into said interstices.

3. A furniture leg floor protector made by the process of claim 1, comprising a body of plasticized thermo-plastic elastomer material and a felt pad attached thereto, the body having a preferably substantially transparent cylindrical portion sized to receive a foot portion of said furniture leg and an integral bottom wall, the felt pad having a fibrous surface attached to an underside, in use, of said bottom wall.

4. A furniture leg floor protector made by the process of claim 2, comprising:
a body of plasticized thermo-plastic elastomer material comprising a preferably substantially transparent cylindrical sidewall having a semi-rigid lower sidewall portion and a stretchable, flexible upper sidewall portion said semi-rigid lower sidewall portion sized to receive a foot portion of said furniture leg and having an integral bottom wall, and said stretchable flexible upper side wall portion being elastically stretchable to allow the foot portion to be received in the lower sidewall portion and then to frictionally elastically engage the furniture leg above the foot portion,
the floor protector further comprising a felt pad having an upper surface molded into a lower surface of said bottom wall whereby said felt pad is permanently bonded to said bottom wall without adhesive.

5. A furniture leg floor protector as claimed in claim 3, wherein said felt pad comprises any one of the group of polyester, wool, nylon, rayon, polytetrafluoroethylene and cotton.

6. A furniture leg floor protector as claimed in claim 3, wherein said pad comprise a mixture of any two of the group of polyester, wool, nylon, rayon, polytetrafluoroethylene and cotton.

7. A furniture leg floor protector as claimed in claim 3, wherein a top portion of said upper side wall is of the same thickness as a lower most portion of said upper side wall.

8. A furniture leg floor protector as claimed in claim 3, wherein the thickness of said upper side wall decreases from a lower most position to an uppermost position.

9. A furniture leg floor protector as claimed in claim 3, wherein said felt pad is round with planar top and bottom surfaces.

10. A furniture leg floor protector as claimed in claim 3, wherein said felt pad includes a convex lower outer surface.

11. A furniture leg floor protector as claimed in claim 3, wherein said felt pad includes a central aperture.

12. A furniture leg floor protector according to claim 3, further comprising a circumferential lip extending from said lower sidewall portion to surround said felt pad.

13. A furniture leg floor protector according to claim 3, wherein the upper sidewall portion is stretchable to such an extent that the upper sidewall portion can be rolled or folded outwards to overlie the lower sidewall portion.

14. A furniture leg floor protector, as claimed in claim 3, wherein said upper sidewall portion is tapered inwardly and upwardly.

15. A furniture leg floor protector as claimed in claim 3, wherein said upper sidewall portion is thinner than said lower sidewall portion.
